(19) United States
(12) Patent Application Publication
(10) Pub. No.: US 2023/0413825 A1
(43) Pub. Date: Dec. 28, 2023

(54) SHORT AND LONG TERM DISINFECTANTS UTILIZING ALCOHOL AND ZINC PYRITHIONE

(71) Applicant: CAO Group, Inc., West Jordan, UT (US)

(72) Inventor: Steven D Jensen, South Jordan, UT (US)

(73) Assignee: CAO Group, Inc., West Jordan, UT (US)

(21) Appl. No.: 17/904,524

(22) PCT Filed: Feb. 11, 2021
(86) PCT No.: PCT/US2021/017689

§ 371 Date: Aug. 18, 2022

Related U.S. Application Data
(60) Provisional application No. 62/982,592, filed on Feb. 27, 2020.

(51) Int. Cl. A01N 55/02; A01N 25/04; A01N 31/02

(52) U.S. Cl. CPC A01N 55/02; A01N 25/04; A01N 31/02

(57) ABSTRACT

A disinfectant with improved properties may feature combinations of water, alcohol, and zinc pyrithione. Preferred embodiments utilize ethanol, menthol and isopropanol in various concentrations based upon effectiveness. Zinc pyrithione is then dissolved in an admixture of alcohol and water up to its saturation point, which should be a minimum of 50 ppm and may approach 60 ppm.

### CROSS-REFERENCES TO RELATED APPLICATIONS

The present invention claims priority as a non-provisional perfection of prior filed U.S. Application No. 62/982,592, filed on Feb. 27, 2020 and incorporates the same by reference herein in its entirety.

### FIELD OF THE INVENTION

The present invention relates to the field of disinfectants and more particularly relates to a surface disinfectant containing a combination of alcohol and zinc pyrithione.

### BACKGROUND OF THE INVENTION

This patent relates to surface disinfection compositions; these compositions are designed to disinfect common surfaces by various application means such as: spray and air dry, pre-moistened wipes, spray and wipe, flooding, blotting and other means of application. Most contemporary surface disinfectants on the market are effective only in the short-term and are designed for an immediate anti-microbial effect at time of application. Most contemporary surface disinfectants are designed to disinfect clean surfaces; they are not designed to disinfect surfaces contaminated with biological fluids such as saliva, blood, sweat, feces, urine, and other contaminants. Many contaminants are not readily visible on ordinary surfaces and the clinician is completely unaware that a surface requires the physical removal of these contaminants before an any effective type of disinfection can occur.

The present invention is to provide surface disinfection compositions that are designed to disinfect contaminated surface; and provide a long term bacteriostatic and/or bactericidal surface, especially through cumulative use. The present invention represents a departure from the prior art in that the disinfectants of the present invention allows for the combination of alcohols and zinc pyrithione as a synergistic antagonist to combat microbes in both the short and long-term and as an effective means to disinfect contaminated surfaces.

### SUMMARY OF THE INVENTION

In view of the foregoing disadvantages inherent in the known types of disinfectants, an improved disinfectant may comprise a combination of alcohols and zinc pyrithione to accomplish its cleansing and long-term anti-microbial objectives.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### DETAILED DESCRIPTION OF THE PREFERRED EMBODIMENT

Preferred embodiments of the disinfectant containing zinc pyrithione and alcohol is herein described. It should be noted that the articles “a”, “an”, and “the”, as used in this specification, include plural referents unless the content clearly dictates otherwise.

Alcohols and zinc pyrithione work together providing an enhanced effect against microbes, especially on contaminated surfaces. The alcohol provides fluid mobility and a powerful, initial, short-term anti-microbial effect while the zinc pyrithione provides a broad spectrum anti-microbial surface effect over a longer term, especially after cumulative use. Together they provide a synergistic effect against a broad spectrum of microorganisms such as bacteria, spores, viruses, yeasts, fungi, and other microorganisms, and especially against surfaces that are contaminated with biological fluids.

The present invention utilizes liquid alcohols such as methanol, ethanol, propanol, butanol, isopropanol, t-butyl alcohol, and all other fluidic alcohols that have antimicrobial activity.

The present invention also utilizes the salts of pyrithione, especially the zinc salt. Zinc pyrithione is an excellent broad-spectrum antimicrobial even at very low concentrations. Zinc pyrithione is an inorganic salt that is nearly insoluble in water with a solubility of about 8 ppm; however, the solubility of zinc pyrithione in solution in an admixture of alcohols and water can reach about 60 ppm. Since zinc pyrithione is an inorganic salt, it does not evaporate along with volatile alcohol solutions and remains on the surface after application as a thinly disseminated layer that provides a long-term antimicrobial effect. The benefit is further enhanced by repeated use as the disseminated layer slowly accumulates in density, thus providing an improved bacteriostatic surface.

Water is essential for life and does not in the general sense have antimicrobial properties. Nevertheless, water can increase the antimicrobial efficiency of alcohols. Water has a slower evaporation rate than many volatile alcohols. However, when an admixture of water and volatile alcohols are utilized as a surface disinfectant, the azeotrope formed allows the solution to evaporate at a slower rate, thus providing a prolonged contact time with the surface and therefore a correspondingly higher microbe kill rate. Solutions of water and alcohol follow the law of diminishing returns with respect to antimicrobial efficiency. This is to say that adding more and more water to alcohols will eventually dilute the alcohol to the point where the benefit from the decrease in the evaporation rate is no longer realized. Therefore, there is a range of water and alcohol concentrations that result in maximal antimicrobial efficiency.

One embodiment of the present invention prefers ethanol in the range of 85%-100%; with the remaining portion of the admixture being water. The most preferred range is 95% ethanol with 5% water. Another embodiment of the present invention prefers methanol in the range of 75%-100%; with the remaining portion of the admixture being water. The most preferred range is 90% methanol with 10% water. A third embodiment of the present invention prefers isopropanol in the range of 70%-100%; with the remaining portion of the admixture being water. The most preferred range is 70% isopropanol with 30% water. Zinc pyrithione may be added to these mixtures to the point of saturation, measured in parts per million (ppm). An embodiment of the present invention comprises 95% ethanol with 5% water and an addition of at least 50 ppm zinc pyrithione.

As a rule, embodiments of the present invention seek to maximize:
1. The mixtures of alcohol and water that result in the greatest antimicrobial efficiency with respect to a surface disinfectant; and,
2. The concentration of dissolved zinc pyrithione in water and/or alcohol solutions.

Though not preferred, a “shake well” slurry or suspension of undissolved zinc pyrithione in water and/or alcohol is within the scope of this patent; because practitioners would tend to frown over a white colored residue left behind on their countertops, the ideal surface disinfectant should leave no residue behind that is visible to the naked eye. However, where aesthetics is not a concern and a heavy-duty surface disinfectant is desired, a slurry then becomes an option.

Although the present invention has been described with reference to preferred embodiments, numerous modifications and variations can be made and still the result will come within the scope of the invention. No limitation with respect to the specific embodiments disclosed herein is intended or should be inferred.

1. A solution soluble surface disinfection composition comprising:
alcohol;
water, said alcohol and water combined to form an admixture of at least 90% alcohol by weight; and,
zinc pyrithione
wherein zinc pyrithione is dissolved in the admixture of alcohol and water in concentrations up to its saturation point.

2. (canceled)

3. The solution soluble surface disinfection composition of claim 1, the alcohol being selected form the set of alcohols consisting of: methanol, ethanol, propanol, butanol, isopropanol, and t-butyl alcohol.

4. The solution soluble surface disinfection composition of claim 1, the alcohol being ethanol and the admixture of ethanol and water being 95% by weight ethanol and 5% water.

5. The solution soluble surface disinfection composition of claim 1, the alcohol being menthol and the admixture of menthol and water being 90% by weight menthol and 5% water.

6. (canceled)

7. The solution soluble surface disinfection composition of claim 1, the concentration of zinc pyrithione within the solution being between 50 and 60 ppm, inclusively.

8. A solution soluble surface disinfection composition comprising:
ethanol;
water, said ethanol and water combined to form an admixture of at least 95% alcohol by weight; and,
zinc pyrithione
wherein zinc pyrithione is dissolved in the admixture of alcohol and water in concentrations up to its saturation point.

9. (canceled)

10. (canceled)

11. The solution soluble surface disinfection composition of claim 8, the concentration of zinc pyrithione within the solution being between 50 and 60 ppm, inclusively.
